(19) United States
(12) Patent Application Publication
(10) Pub. No.: US 2011/0315534 A1
(43) Pub. Date: Dec. 29, 2011

(54) LIGHT GUIDE SHEET, MOVABLE CONTACT BODY USING SAME, AND SWITCH

(75) Inventors: Koji Tanabe, Osaka (JP); Naoki Tatehata, Kyoto (JP); Hirotoshi Watanabe, Osaka (JP); Tsutomu Aisaka, Osaka (JP)

(73) Assignee: PANASONIC CORPORATION, Osaka (JP)

(21) Appl. No.: 13/254,506

(22) PCT Filed: Jun. 28, 2010
(86) PCT No.: PCT/JP2010/004260

§ 371 Date: Sep. 2, 2011

(30) Foreign Application Priority Data
Jun. 29, 2009 (JP) 2009-153390
May 11, 2010 (JP) 2010-108870

(51) Int. Cl. H01H 13/14; F21V 13/02

(52) U.S. Cl. 200/530; 362/343

(57) ABSTRACT

A light guide sheet guides light emitted from a light introducer. The light guide sheet includes a film-shaped substrate, a light emitting section formed on the substrate, and a belt-shaped light-blocking section. The light emitting section reflects or scatters light transmitting in the substrate to the outside. The light-blocking section is formed in the substrate by coloring a position of the substrate to a color. In the position, the light emitting section is not formed. The color absorbs the light which is emitted from the light introducer. The light emitting section can alternatively be composed of a plurality of projections and/or a plurality of recesses. Such a light-blocking section is formed in a position of the substrate where the projections and/or the recesses are not formed.

### TECHNICAL FIELD

The present invention relates to a light guide sheet mainly used for operation of various electronic apparatuses, a movable contact body and a switch both using the sheet.

### BACKGROUND ART

In recent years, the number of various electronic apparatuses, especially portable terminals such as mobile telephones and electronic cameras has increased. Many portable terminals include light emitting diodes or EL devices to illuminate their operating parts. This enables users to distinguish between push buttons and a display sheet in dark environments. There is a demand for movable contact bodies and switches that are user-friendly and provide a variety of illumination when used in the apparatuses. Such a conventional light guide sheet and a movable contact body are described with reference to FIGS. 10 and 11. In these drawings, the dimensions of some parts are exaggerated for easy understandings.

FIGS. 10 and 11 are a sectional view and a plan view, respectively, of a conventional switch. The switch includes movable contact body 36, wiring board 37, and a plurality of fixed contacts 38. Movable contact body 36 includes light guide sheet 33, film-shaped light-transmissive base sheet 34, and dome-shaped movable contacts 35 made of conductive sheet metal.

Light guide sheet 33 includes film-shaped light-transmissive substrate 31, and light emitting sections 32 each of which is composed of a plurality of projections 320 formed in predetermined positions on the lower surface of substrate 31. There are provided slits between light emitting sections 32. For example, as shown in FIG. 11, a plurality of slits 31A are formed in the shape of the letter C around light emitting section 32A, and T-shaped slit 31B is formed between light emitting sections 32B and 32C.

Base sheet 34 is attached at predetermined positions of the upper surface thereof to the lower surface of light guide sheet 33 via an adhesive (not shown). Each of movable contacts 35 is attached to the lower surface of base sheet 34 under a respective one of light emitting sections 32.

Wiring board 37 is provided on its upper and lower surfaces with a plurality of wiring patterns (not shown). Wiring board 37 also includes fixed contacts 38 on its upper surface. Each of fixed contacts 38 includes central fixed contact 38A and outer fixed contact 38B surrounding central fixed contact 38A. Central fixed contact 38A is substantially circular, and outer fixed contact 38B are substantially horseshoe-or ring-shaped.

Movable contact body 36 is attached to the upper surface of wiring board 37 such that the outer periphery of each of movable contacts 35 is placed on a respective one of outer fixed contacts 38B, and that the center of the lower surface of each of movable contacts 35 faces a respective one of central fixed contact 38A with predetermined space therebetween.

Light-emitting devices 39 composed, for example, of light emitting diodes are mounted beside light guide sheet 33 on the upper surface of wiring board 37 so as to introduce light on the ends of light guide sheet 33. For example, in FIG. 11, light-emitting device 39A is located at the right of light emitting section 32A, and light-emitting device 39B is located at the bottom of light emitting section 32B with their light emitting surfaces facing the end faces of substrate 31.

The switch thus structured is installed on the control panel of an electronic apparatus such as a mobile telephone. The switch further includes film-shaped light-transmissive display sheet 40 under the control panel. Display sheet 40 includes, on its lower surface, painted part 40A formed by printing or other methods, and a plurality of display sections 40B formed by hollowing predetermined positions of painted part 40A out in the shape of characters and symbols. Each of display sections 40B is located on a respective one of light emitting sections 32 of light guide sheet 33. Fixed contacts 38 and light-emitting devices 39 are connected to an electronic circuit of the apparatus (not shown) via wiring patterns and the like.

When the user pushes desired display section 40B of display sheet 40 down, light guide sheet 33 and base sheet 34 under display section 40B are bent to push the center of movable contact 35. When a predetermined compressive force is applied, movable contact 35 is elastically inverted downward with a click feeling, and comes into contact, at the center of its lower surface, with central fixed contact 38A. As a result, central fixed contact 38A is electrically connected to outer fixed contacts 38B.

When the user releases the compressive force applied to display sheet 40, movable contact 35 is elastically inverted upward by the elastic returning force. The center of the lower surface of movable contact 35 moves away from central fixed contact 38A, making central fixed contact 38A electrically disconnected from outer fixed contacts 38B.

The electrical connection and disconnection of fixed contacts 38 enables switching between various functions of the apparatus. When the electronic circuit of the apparatus supplies electric power to light-emitting devices 39, light-emitting devices 39A and 39B emit light. Assume that light-emitting device 39A emits orange light, and light-emitting device 39B emits green light. In this case, the orange light from the right end face, and the green light from the bottom end face enter light guide sheet 33, and propagate through substrate 31 while being reflected.

The light is diffused and reflected by projections 320 of light emitting sections 32A and 32B on the lower surface of substrate 31, thereby illuminating display sections 40B of display sheet 40 from below. As a result, display sections 40B on light emitting section 32A are illuminated orange, and display sections 40B on light emitting section 32B are illuminated green. This enables the user to distinguish characters and symbols of display sections 40B in dark environments, thereby the user can operate the apparatus easily.

Thus, when the user pushes display sheet 40, display sheet 40 pushes the upper surface of light guide sheet 33. This elastically inverts movable contact 35, thereby providing electrical continuity of fixed contact 38. The light from light-emitting devices 39 enters light guide sheet 33 through the end faces so as to make light emitting sections 32 emit light. As a result, display sections 40B of display sheet 40 are illuminated.

As mentioned above, light-emitting devices 39A and 39B emit light of different colors. Between light emitting sections 32, there are slits 31A and slit 31B. Slits 31A and 31B are formed at predetermined positions to prevent light emitting sections 32 from being illuminated by the light of different colors which is emitted from light-emitting devices 39A, 39B and is then mixed in light guide sheet 33.

It is possible to turn light emitting section 32A off and to turn light emitting section 32B on. Even in this case, slits 31A and 31B prevent a portion supposed to be in the off state from being dimly illuminated by the light which is illuminating another portion. One such switch is disclosed in Patent Literature 1.

As shown in FIG. 11, however, there are crosspieces 31C and 31D remaining near light emitting sections 32A and 32B instead of slits in substrate 31. This makes it difficult to completely shield light from each of light emitting sections 32 to each other. The larger the number of light-emitting devices 39 so as to increase brightness, the easier it is to cause light to leak or to be mixed with light of other colors.

### CITATION LIST

### Patent Literature

Patent Literature 1: Japanese Patent Unexamined Publication No. 2009-146870

### SUMMARY OF THE INVENTION

The present invention is a light guide sheet which provides a variety of illumination while preventing light emitted from light-emitting devices from leaking or being mixed with light emitted from other light-emitting devices; a movable contact body and a switch both using the sheet.

A light guide sheet of the present invention guides light emitted from a light introducer. The light guide sheet includes a film-shaped substrate, a light emitting section formed on the substrate, and a belt-shaped light-blocking section. The light emitting section reflects or scatters light transmitting through the substrate to the outside. The light-blocking section is formed in the substrate by coloring a position of the substrate to a color. The position does not include the light emitting section, and the color absorbs the light emitted from the light introducer.

Another light guide sheet of the present invention includes a light emitting section composed of a plurality of projections and/or a plurality of recesses. This light guide sheet includes a light-blocking section formed in a position of the substrate that does not include the projections and/or recesses.

Even when the light guide sheet includes a plurality of light emitting sections, the light-blocking section formed in the substrate prevents light in a light emitting section from leaking to other light emitting sections, being mixed with light of other colors, or leaking to the outside. In addition, two regions in one light emitting section can emit light of two different colors. This enables the light guide sheet to provide a variety of highly visible illumination.

### BRIEF DESCRIPTION OF DRAWINGS

FIG. 1 is a sectional view of a movable contact body according to a first exemplary embodiment of the present invention.

FIG. 2 is a plan view of the movable contact body shown in FIG. 1.

FIG. 3 is a sectional view of a switch using the movable contact body shown in FIG. 1.

FIG. 4A is a partial sectional view showing a process of forming a light-blocking section on a substrate in the movable contact body shown in FIG. 1.

FIG. 4B is a partial sectional view showing another process of forming a light-blocking section on the substrate in the movable contact body shown in FIG. 1.

FIG. 4C is a partial sectional view showing still another process of forming a light-blocking section on the substrate in the movable contact body shown in FIG. 1.

FIG. 5 is a sectional view of a movable contact body according to a second exemplary embodiment of the present invention.

FIG. 6 is a plan view of the movable contact body shown in FIG. 5.

FIG. 7A is a plan view of another movable contact body according to the second exemplary embodiment of the present invention.

FIG. 7B is an enlarged view of a display section on the movable contact body shown in FIG. 7A.

FIG. 8 is a sectional view showing another structure of the movable contact body shown in FIG. 7A.

FIG. 9 is a sectional view showing another structure of the movable contact body shown in FIG. 2.

FIG. 10 is a sectional view of a conventional switch.

FIG. 11 is a plan view of a movable contact body shown in FIG. 10.

### DETAILED DESCRIPTION OF PREFERRED EMBODIMENTS

Embodiments of the present invention are described as follows with reference to accompanied drawings. In these drawings, the dimensions of some parts are enlarged for clarity.

### First Exemplary Embodiment

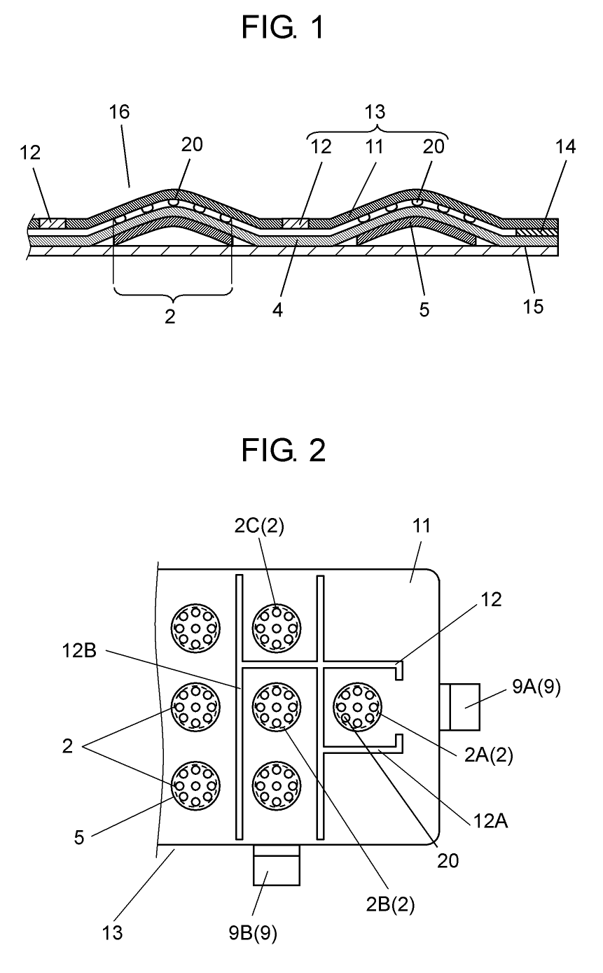

FIGS. 1 and 2 are a sectional view and a plan view, respectively, of a movable contact body according to a first exemplary embodiment of the present invention. Movable contact body 16 includes light guide sheet 13, film-shaped base sheet 4, and movable contacts 5. Light guide sheet 13 includes film-shaped substrate 11, a plurality of light emitting sections 2 each composed of a plurality of projections 20 and formed on substrate 11, and belt-shaped light-blocking sections 12.

Light-transmissive substrate 11 is a flexible sheet made, for example, of polyurethane, silicone, styrene, or polycarbonate. Projections 20 are dotted at predetermined positions of the lower surface of substrate 11 by, for example, printing white or milky white polyester, epoxy or the like. Light emitting sections 2 on substrate 11 reflect or scatter the light transmitting through substrate 11, to the outside.

Each of light-blocking sections 12 extends between light emitting sections 2 in substrate 11; for example, around light emitting section 2A and between light emitting sections 2B and 2C. More specifically, belt-shaped light-blocking sections 12, which are connected to each other and have a dark color such as black, dark blue or the like, surround light emitting sections 2A, 2B, and 2C.

Light-blocking sections 12 are easily formed by applying ink to the surface of substrate 11 by, for example, ink jetting and heating it at a predetermined temperature for a predetermined time. The ink is prepared by dissolving a dark-colored dye in a solvent that causes substrate 11 to swell. When substrate 11 is made of polyurethane, an azo-based dye is dissolved in a solvent of, for example, acetone, cyclohexanone or the like. When substrate 11 is made of silicone, an oil-soluble premetallized dye is dissolved in gasoline, benzene or the like. When substrate 11 is made of polycarbonate, an azo-based dye is dispersed, for example, in toluene, xylene or the like.

It is alternatively possible to prepare ink by adding acrylic, phenoxy, or other resin to these solvents. In this case, the ink is printed on the surface of substrate 11 by, for example, screen printing, and is heated to make the dark-colored dye permeate into substrate 11. This method can form light-blocking sections 12 having a dark color such as black, dark blue or the like. In other words, light-blocking sections 12 are formed in substrate 11 by coloring the positions of substrate 11, where light emitting section 2 is not formed.

Base sheet 4 is a flexible film made, for example, of polyethylene terephthalate, polycarbonate or the like. The outer periphery of base sheet 4 is attached to the lower surface of light guide sheet 13 via adhesive 14 at predetermined positions. Adhesive 14 is made, for example, of acrylic, silicone or the like. Dome-shaped movable contacts 5 are made of sheet metal such as a copper alloy or steel. Each of movable contacts 5 is attached to the lower surface of base sheet 4 under a respect one of light emitting sections 2. Movable contact body 16 is structured as described hereinbefore.

Film-shaped separator 15 made, for example, of polyethylene terephthalate is attached to base sheet 4 so as to cover the entire lower surface of base sheet 4. Separator 15 protects the lower surface of movable contacts 5 from dust and dirt during storage or transportation.

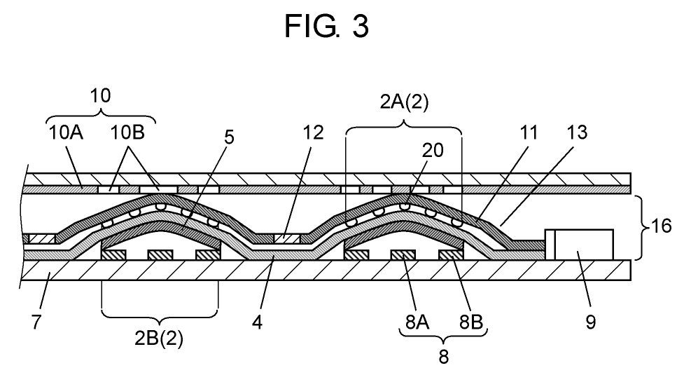

FIG. 3 is a sectional view of a switch using movable contact body 16. The switch includes movable contact body 16, wiring board 7, and a plurality of light-emitting devices 9 as light introducers. Wiring board 7 can be a film made of polyethylene terephthalate, polycarbonate or the like, or a plate made of paper phenol, glass-filled epoxy or the like. Wiring board 7 is provided on its upper and lower surfaces with wiring patterns (not shown) made, for example, of copper. Wiring board 7 also includes a plurality of fixed contacts 8 on its upper surface. Fixed contacts 8 are made, for example, of copper, carbon or the like. Each of fixed contacts 8 includes circular central fixed contact 8A, and horseshoe- or ring-shaped outer fixed contacts 8B surrounding central fixed contact 8A.

Movable contact body 16 from which separator 15 has been removed is attached to the upper surface of wiring board 7 such that the outer periphery of each movable contact 5 is placed on outer fixed contacts 8B, and that the center of the lower surface of each movable contact 5 faces central fixed contact 8A with a predetermined space therebetween.

Light-emitting devices 9, which may be composed of light emitting diodes and can introduce light on the ends of substrate 11 of light guide sheet 13, are mounted beside light guide sheet 13 on the upper surface of wiring board 7. For example, in FIG. 2, light-emitting device 9A is located at the right of light emitting section 2A, and light-emitting device 9B is located at the bottom of light emitting section 2B with their light emitting surfaces facing the end faces of substrate 11. The switch is structured as described hereinbefore.

Film-shaped light-transmissive display sheet 10 is placed above or on light guide sheet 13. Display sheet 10 includes, on its lower surface, painted part 10A formed by printing or other methods, and a plurality of display sections 10B formed by hollowing predetermined positions of painted part 10A out in the shape of characters and symbols. Display sections 10B are located above light emitting sections 2 of light guide sheet 13.

The switch thus structured is installed on the control panel of an electronic apparatus such as a mobile telephone. Central fixed contacts 8A, outer fixed contacts 8B, and light-emitting devices 9 are connected to an electronic circuit of the apparatus (not shown) via wiring patterns or the like.

When the user pushes desired display section 10B of display sheet 10 down, light guide sheet 13 and base sheet 4 under display section 10B are bent to push the center of dome-shaped movable contact 5. When a predetermined compressive force is applied, movable contact 5 is elastically inverted downward with a click feeling, and comes into contact, at the center of its lower surface, with central fixed contact 8A. As a result, central fixed contact 8A is electrically connected to outer fixed contacts 8B.

When the user releases the compressive force applied to display sheet 10, movable contact 5 is elastically inverted upward by the elastic returning force. The center of the lower surface of movable contact 5 moves away from central fixed contact 8A, making central fixed contact 8A electrically disconnected from outer fixed contacts 8B.

The electrical connection and disconnection of fixed contacts 8 enables switching between various functions of the apparatus. When the electronic circuit of the apparatus supplies electric power to light-emitting devices 9, light-emitting devices 9A and 9B emit light. Assume that light-emitting device 9A emits orange light, and light-emitting device 9B emits green light. In this case, the orange light from the right end face and the green light from the bottom end face enter light guide sheet 13, and propagate through substrate 11 while being reflected.

The light is diffused or reflected by projections 20 of light emitting sections 2A and 2B, thereby illuminating display sections 10B of display sheet 10 from below. As a result, display sections 10B on light emitting section 2A are illuminated orange, and display sections 10B on light emitting section 2B are illuminated green. This enables the user to distinguish characters and symbols of display sections 10B in dark environments, thereby the used can operates of the apparatus with ease.

Light-blocking sections 12, which are belt-shaped and have a dark color such as black, dark blue or the like, extend in substrate 11; for example, around light emitting section 2A, or between light emitting sections 2B and 2C. In other words, light-blocking sections 12 are formed in substrate 11 by coloring the positions of substrate 11 where light emitting section 2 is not provided. The positions of substrate 11 are colored to a color which absorbs the light emitted from light-emitting devices 9. More specifically, projections 20 compose light emitting sections 2, and light-blocking sections 12 extend between light emitting sections 2. For this reason, when display sections 10B are illuminated with orange light emitted from light emitting section 2A and green light emitted from light emitting section 2B as described above, the orange and green light is not mixed inside light guide sheet 13.

As shown in FIG. 2, light guide sheet 13 includes C-shaped light-blocking section 12A, which almost completely surrounds light emitting section 2A, and C-shaped light-blocking section 12B, which almost completely surrounds light emitting section 2B. Light-blocking sections 12A and 12B shield the orange and green light emitted from light emitting sections 2A and 2B, respectively. Consequently, the light from light-emitting device 9A doesn't leaks to light emitting section 2B, or the light from light-emitting device 9B doesn't leaks to light emitting section 2A. As a result, display sections 10B are not illuminated with the mixed light of orange and green.

When light-emitting device 9B is in the off state and only light-emitting device 9A is in the on state, light-emitting device 9A emits light to light emitting section 2A. The light from light-emitting device 9A is shielded almost completely by light-blocking section 12A, and is prevented from dimly illuminating light emitting sections 2B and 2C.

Dark-colored light-blocking sections 12 are formed so as to surround each of light emitting sections 2A and 2B in substrate 11, thus they partition light emitting sections 2A, 2B, and 2C from each other. This enables the light guide sheet to provide a variety of highly visible illumination while preventing light in a light emitting section from leaking to other light emitting sections or from being mixed with other light.

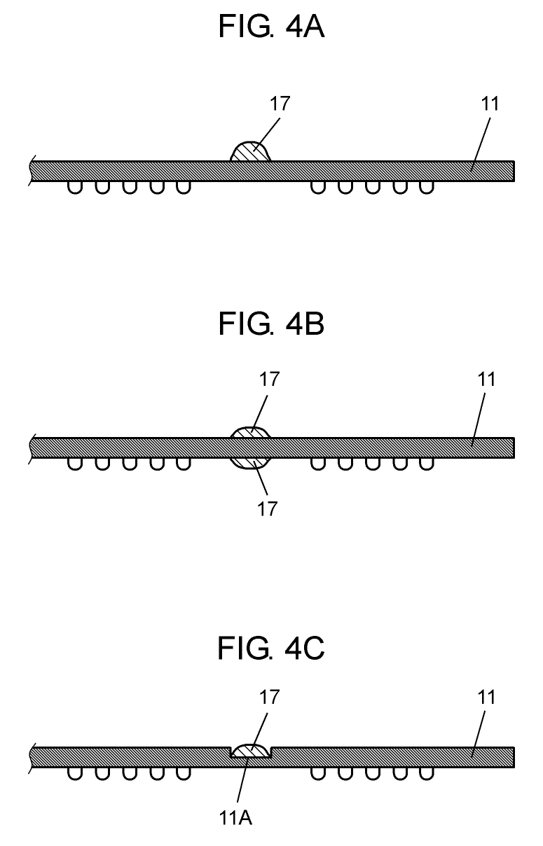

As described above, light-blocking sections 12 are easily formed by applying ink to the surface of substrate 11 by ink jetting, screen printing, or other techniques. The ink is prepared by dissolving, in a solvent, a dark-colored dye that can permeate into substrate 11. After applying the ink to the surface of substrate 11, substrate 11 is usually heated at a predetermined temperature. During the heating, the dye permeates into substrate 11, thereby forming light-blocking sections 12. A preferable method for forming light-blocking sections 12 when substrate 11 is thick will be described as follows with reference to FIGS. 4A to 4C. FIGS. 4A to 4C are partial sectional views showing a process of forming light-blocking sections 12 in substrate 11.

Assume that substrate 11 is as thick as about 0.2 mm, and that ink 17 is applied only to one side of substrate 11 as shown in FIG. 4A. In this case, the speed at which substrate 11 is colored dark by the permeating dye decreases with increasing depth from its upper surface. It takes 10 to 40 minutes to form light-blocking sections 12 at temperatures of 100 to 160° C.

It is, therefore, preferable to apply ink 17 to both sides of substrate 11 as shown in FIG. 4B. This can reduce the heating time to form light-blocking sections 12. The thickness of light-blocking sections 12 is 0.5 mm or more when ink 17 is applied to one side of substrate 11, but can be as small as about 0.3 mm when ink 17 is applied to both sides. In the latter case, light-blocking sections 12 can be formed even in narrow spaces between light emitting sections 2.

It is alternatively possible to form groove 11A in one or both sides of substrate 11 by, for example, laser processing as shown in FIG. 4C, so that substrate 11 into which ink 17 permeates can be thinner. Also with this method, light-blocking sections 12 can be formed even in narrow spaces between light emitting sections 2 in a short time.

A mixture of light emitted from a plurality of light introducers can be reduced to some extent by providing slits between light emitting sections as in Japanese Patent Unexamined Publication No. 2009-146870. The same effect as light-blocking sections 12 of the present invention can be obtained by filling the slits with ink. Providing slits, however, makes the substrate too fragile to be easily handled. In addition, fixing the substrate requires fixing many positions of the substrate by using an adhesive or other materials. In contrast, light-blocking sections 12 in the present exemplary embodiment are integrated into substrate 11 by coloring substrate 11. Therefore, light-blocking sections 12 have the same strength as that of substrate 11, causing no problem with handing them.

### Second Exemplary Embodiment

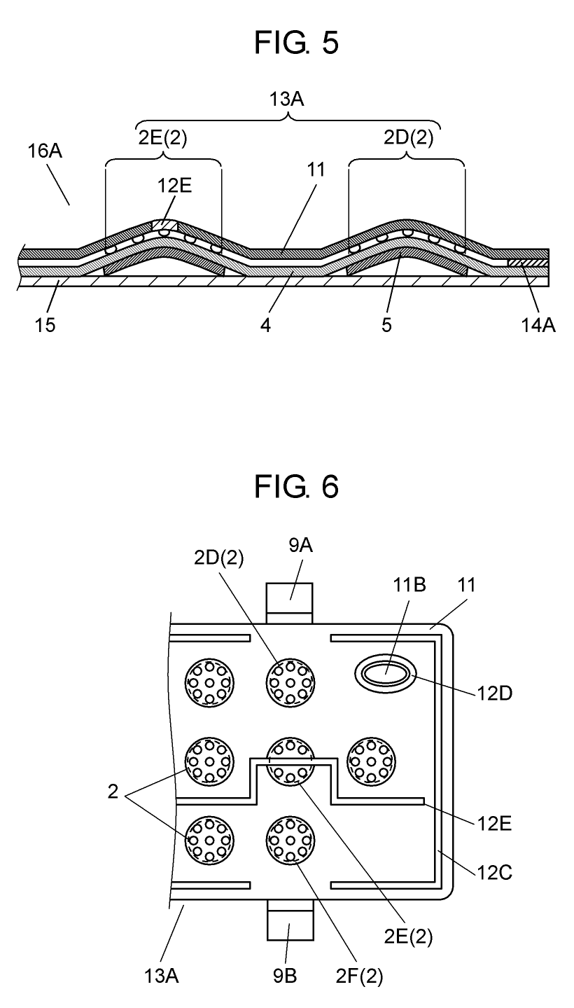

FIGS. 5 and 6 are a sectional view and a plan view, respectively, of a movable contact body according to a second exemplary embodiment of the present invention. In the following description, the same components as in the first exemplary embodiment are denoted by the same reference numerals, and thus a detailed description thereof may be omitted.

Light emitting sections 2, which may be composed of a plurality of white or milky white projections 20, are dotted on the lower surface of substrate 11 as in the first exemplary embodiment. The movable contact body of the present exemplary embodiment includes belt-shaped dark-colored light-blocking section 12C along the outer periphery of substrate 11 so as to surround light emitting sections 2. Substrate 11 is provided with hole 11B. The movable contact body further includes light-blocking sections 12D and 12E. Light-blocking section 12D is formed along the outer periphery of hole 11B. Light-blocking section 12E is belt-shaped and is formed at the middle of substrate 11 so as to extend through the center of light emitting section 2E. Thus, projections 20 compose light emitting section 2E, and light-blocking section 12E extends through light emitting section 2E. Light guide sheet 13A is structured as described hereinbefore. Light-blocking sections 12C, 12D, and 12E are formed in the same manner as light-blocking sections 12 of the first exemplary embodiment. In other words, light-blocking sections 12C and 12D are formed in substrate 11 by coloring the positions of substrate 11 where light emitting section 2 is not formed. The positions of substrate 11 are colored to a color which absorbs the light emitted from light-emitting devices 9 as the light introducers. Light-blocking section 12E, on the other hand, is formed in substrate 11 by coloring the positions of substrate 11 where projections 20 are not formed to the color which absorbs the light emitted from light-emitting devices 9 as the light introducers.

In the same manner as in the first exemplary embodiment, movable contacts 5 are attached to the lower surface of base sheet 4 under light emitting sections 2. In addition, the outer periphery of base sheet 4 is attached to the lower surface of light guide sheet 13A via adhesive 14A at predetermined positions. In the present exemplary embodiment, however, adhesive 14A has a dark color such as black, dark blue or the like to absorb the light emitted from light-emitting devices 9A and 9B.

Movable contact body 16A thus structured is attached to the upper surface of wiring board 7 having fixed contacts 8 to complete a switch as described in the first exemplary embodiment with reference to FIG. 3. Display sections 10B of display sheet 10 are located on or above light emitting sections 2 of light guide sheet 13A. As shown in FIG. 6, light-emitting device 9A is located over light emitting section 2D, and light-emitting device 9B is located at the bottom of light emitting section 2E, for example.

As shown in FIG. 6, light-blocking section 12E extends around the middle of substrate 11. Light-blocking section 12E shields the orange light emitted from light-emitting device 9A from the top end face into light guide sheet 13A, and the green light emitted from light-emitting device 9B from the bottom end face into light guide sheet 13A. Thus, light-blocking section 12E prevents the different colors of light from being mixed.

Light-blocking section 12E extends through the center of light emitting section 2E. Therefore, light emitting section 2E emits light of different colors between the top and bottom halves unlike light emitting sections 2D and 2F.

More specifically, the light emitting sections located in the upper area of substrate 11, such as light emitting section 2D emit orange light, and the light emitting sections located in the lower area such as light emitting section 2F emit green light. Light emitting section 2E, of which light-blocking section 12E extends through the center, emits orange light in the top half, and green light in the bottom half.

Light-blocking section 12C surrounding light emitting sections is formed along the outer periphery of substrate 11, and light-blocking section 12D is formed along the outer periphery of hole 11B. They prevent the light entering into the substrate 11 from leaking to the outside of substrate 11 or into hole 11B. In other words, light-blocking sections 12C and 12D shield the light entering into substrate 11 so as to prevent the light from leaking to the outside and illuminating unnecessary areas in the apparatus.

Light-blocking sections 12C and 12D are preferably bluish black to absorb the yellowish color of substrate 11. This prevents light emitting sections 2 that are away from light-emitting devices 9 from emitting yellowish light. As a result, all light emitting sections 2 emit light of the same brightness.

In addition, adhesive 14A, which is used to attach the outer periphery of base sheet 4 to the lower surface of light guide sheet 13A at predetermined positions, can be dark colored. This prevents the light emitted from light-emitting devices 9 from leaking to the outside the region of adhesive 14A.

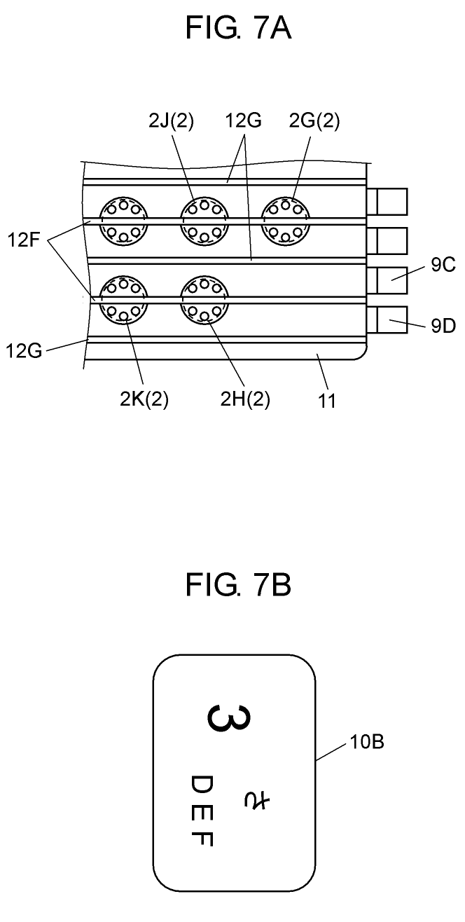

As shown in the plan view of FIG. 7A, it is also possible to provide belt-shaped dark-colored light-blocking sections 12F extending through the centers of light emitting sections 2, or a plurality of light-blocking sections 12G along the outer periphery of substrate 11 or between light emitting sections 2. With this structure, display sections 10B of display sheet 10 can be illuminated in more different ways.

More specifically, light-blocking sections 12F are formed though the centers of light emitting sections 2H and 2K. When light is emitted from light-emitting devices 9C and 9D located on the right of substrate 11 and light-emitting devices 9C and 9D emit orange light and green light, respectively, light emitting sections 2H and 2K emit orange light in the top half, and green light in the bottom half. When display section 10B on light emitting section 2H includes a numeral in the top half, and characters in the bottom half as shown in FIG. 7B, the numeral in the top half is illuminated orange, and the characters in the bottom half are illuminated green.

Assume that light-emitting devices 9C and 9D emit the same color, for example, white. When light is emitted only from light-emitting device 9C, only the top half of light emitting section 2H emits light. As a result, only the numeral in the top half of display section 10B is illuminated. When light is emitted only from light-emitting device 9D, on the other hand, only the bottom half of light emitting section 2H emits light. As a result, only the characters in the bottom half of display section 10B is illuminated.

Thus, light-blocking sections 12F extend through the centers of light emitting sections including light emitting section 2H. This enables light emitting section 2H to emit light of different colors between the top and bottom halves, or to emit light in only one of the top and bottom halves. As a result, display sections 10B are illuminated in more different ways.

Providing slits as disclosed in Japanese Patent Unexamined Publication No. 2009-146870 may prevent movable contacts 5 from being elastically inverted because many positions of movable contacts 5 are fixed using an adhesive or other materials as mentioned above. In the present exemplary embodiment, on the other hand, light-blocking sections 12F extending through the centers of light emitting sections 2 are formed by making a dye permeate into substrate 11. Thus, light-blocking sections 12 are integrated into substrate 11. This allows movable contacts 5 to be elastically inverted, thereby providing the user with a good tactile feeling.

In the above description, light-blocking sections 12E and 12F extend through the centers of light emitting sections 2, but do not necessarily have to extend through the centers, but through the other parts.

Providing light-blocking sections 12G along the outer periphery of substrate 11 or between light emitting sections 2 can prevent the light emitted from light emitting sections 2H and 2K from leaking to the outside, and also prevent the light emitted from light emitting sections 2G and 2J from being mixed with each other.

Light-blocking sections 12F and 12G, and above-mentioned light-blocking sections 12C, 12D, and 12E can be formed by ink jetting, screen printing, or other techniques at the same time to form the light guide sheet. Therefore, even if light-blocking sections are increased in the number, the manufacturing time is not increased, thereby producing a movable contact body and a switch at low cost.

Light-emitting devices 9 may emit blue light with wavelengths of 420 to 480 nm, yellow light with wavelengths of 520 to 600 nm, red light with wavelengths of 650 to 800 nm, or white light produced by mixing blue and yellow light. Whatever color light light-emitting devices 9 emit, light is more securely prevented from leaking or being mixed with light of other colors by providing dark-colored light-blocking sections 12, and selecting a dye that absorbs the emitted light.

Thus, the light of different colors are more securely shielded by forming dark-colored light-blocking sections using a dye that permeates into substrate 11 selected according to the colors of light emitted from light-emitting devices 9. For example, when light-emitting device 9 emits blue light, a carotenoid-based or azo-based dye is used to absorb the blue light. When light-emitting device 9 emits yellow light, a phthalocyanine-based dye is used to absorb the yellow light. When light-emitting device 9 emits red light, an anthraquinone-based dye is used to absorb the red light. Alternatively, a mixture of these dyes can be used to absorb the different colors of light emitted from different light-emitting devices 9. The dyes used to form the light-blocking sections are not limited to the materials mentioned above. One dye or a mixture of dyes can be selected according to the colors of light emitted from light-emitting devices 9.

In the above description, light emitting sections 2 are formed by printing on the lower surface of substrate 11, but may alternatively be formed on the upper surface of substrate 11. Projections 20 can be formed by methods other than printing, such as pasting, ink jetting, laser processing, pressing, molding and the like.

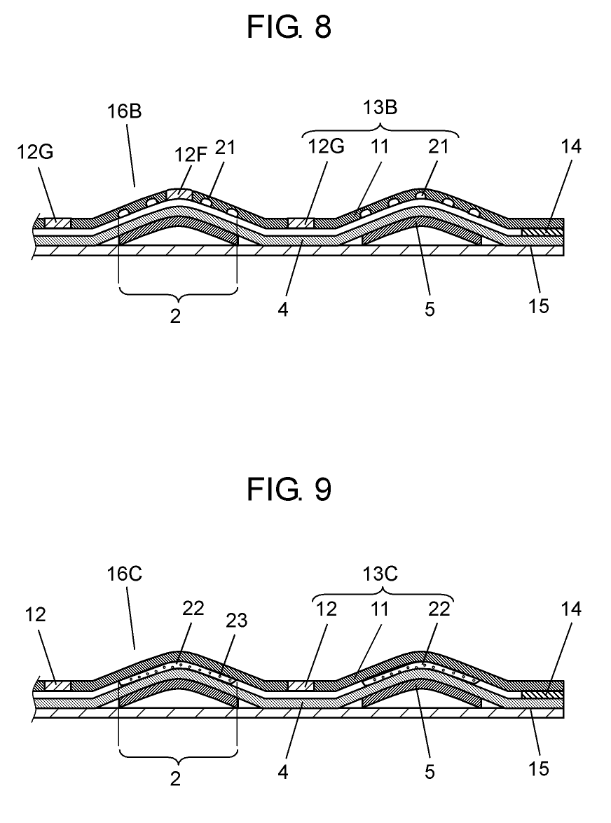

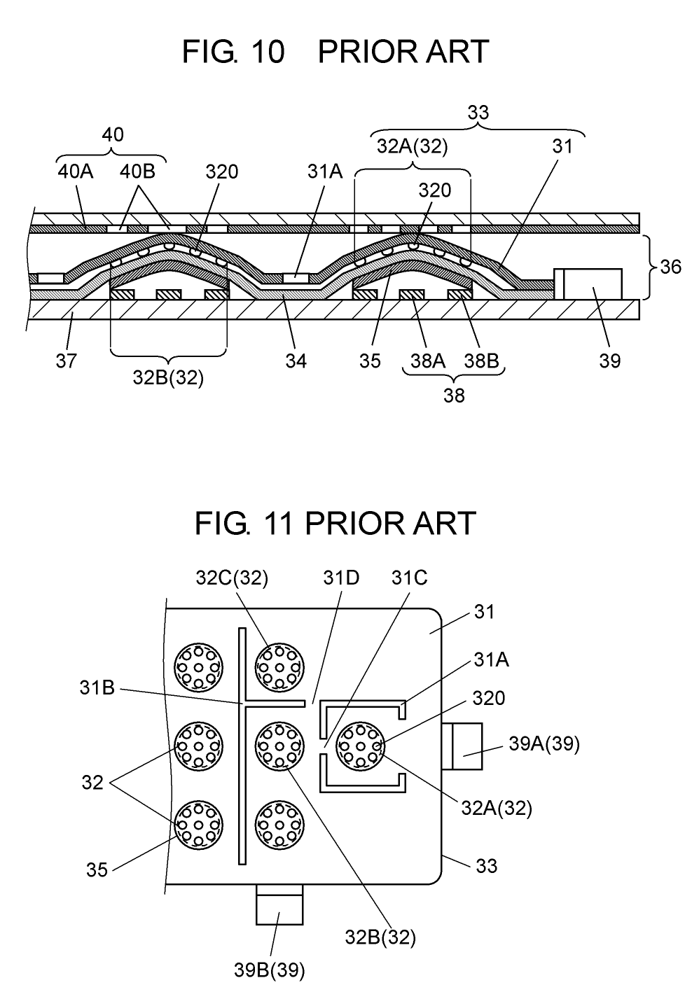

In the above description, light emitting sections 2 are composed of projections 20, but are not limited to this. Other structures of light emitting sections 2 are described as follows with reference to FIGS. 8 and 9. FIG. 8 is a sectional view of another example of the movable contact body shown in FIG. 7A, and FIG. 9 is a sectional view of another example of the movable contact body shown in FIG. 2.

FIG. 8 shows movable contact body 16B having light guide sheet 13B in which light emitting sections 2 are composed of a plurality of recesses 21 formed in substrate 11. In a case that light emitting sections 2 are formed on substrate 11, and are composed of a plurality of projections 20 and/or a plurality of recesses 21 like light-blocking sections 12E and 12F shown in FIGS. 5 and 8, respectively, light-blocking sections can be formed to extend through light emitting sections 2. In addition, light-blocking sections such as light-blocking sections 12G can be formed in positions where light emitting section 2 is not formed.

FIG. 9 shows movable contact body 16C having light guide sheet 13C in which light emitting sections 2 are composed of transparent resin 22 attached to substrate 11, and scattering agent 23 dispersed in transparent resin 22. This configuration can form light emitting sections 2, which reflect or scatter the light transmitting in substrate 11 to the outside, on substrate 11. Scattering agent 23 may be replaced by the formation of fine air bubbles in transparent resin 22. In a case of forming light emitting sections 2 shown in FIG. 9, light-blocking sections 12 can be formed only in positions where light emitting section 2 is not formed. In either structure, light emitting section 2 formed on substrate 11 reflect or scatter the light transmitting through substrate 11 to the outside.

In the above description, base sheet 4 having movable contacts 5 attached to its lower surface is attached to the lower surface of light guide sheet 13 or 13A, but base sheet 4 does not need to be used. Instead, movable contacts 5 may be attached directly to the lower surface of light guide sheet 13 or 13A. This structure reduces the number of components for movable contact bodies 16, 16A, and the switch, thereby simplifying their structure and reducing their costs.

In the above description, each of fixed contacts 8 includes circular central fixed contact 8A, and horseshoe- or ring-shaped outer fixed contacts 8B surrounding central fixed contact 8A. However, the configuration of fixed contact 8 is not limited to those. Fixed contact 8 may be structured in other ways as long as two fixed contacts are formed in the positions on wiring board 7 that allow them to be electrically connected via inverted movable contact 5. More specifically, two fixed contacts may be formed in the positions where movable contact 5 is located. The positions are on the side of wiring board 7 where movable contact body 16 is located. The shapes of the two fixed contacts are not particularly limited. For example, two fixed contacts may be located to be substantially opposed to the center of movable contact 5. In this case, these fixed contacts are electrically connected to each other via the center of inverted movable contact 5.

### INDUSTRIAL APPLICABILITY

The light guide sheet and the movable contact body using the sheet according to the present invention are useful for operating various electronic apparatuses because they provide a variety of illumination without causing light to leak or to be mixed with light of other colors.

### REFERENCE MARKS IN THE DRAWINGS

2, 2A, 2B, 2C, 2D, 2E, 2F, 2G, 2H, 2J, 2K light emitting section
4 base sheet
5 movable contact
7 wiring board
8 fixed contact
8A central fixed contact
8B outer fixed contact
9, 9A, 9B, 9C, 9D light-emitting device (light introducer)
10 display sheet
10A painted part
10B display section
11 substrate
11A groove
12, 12A, 12B, 12C, 12D, 12E, 12F, 12G light-blocking section
13, 13A, 13B, 13C light guide sheet
14, 14A adhesive
15 separator
16, 16A, 16B, 16C movable contact body
17 ink
20 projection
21 recess
22 transparent resin
23 scattering agent

1. A light guide sheet for guiding light emitted from a light introducer, the light guide sheet comprising:
a film-shaped substrate;
a light emitting section formed on the substrate, the light emitting section reflecting or scattering light transmitting through the substrate to an outside; and
a belt-shaped light-blocking section formed in the substrate at a place other than the light emitting section and colored in a color which can absorb the light emitted from the light introducer and transmitted through the substrate.

2. The light guide sheet according to claim 1,
wherein the light emitting section is one of a plurality of light emitting sections and the light guide sheet comprises the plurality of light emitting sections; and
the light-blocking section is formed between the light emitting sections.

3. The light guide sheet according to claim 1,
wherein the light-blocking section is formed along an outer periphery of the substrate.

4. The light guide sheet according to claim 1,
wherein the substrate has a hole, and the light-blocking section surrounds the hole.

5. A movable contact body comprising:
a light guide sheet for guiding light emitted from a light introducer; and
a dome-shaped movable contact made of sheet metal,
wherein the light guide sheet comprises:
a film-shaped substrate;
a light emitting section formed on the substrate, the light emitting section reflecting or scattering light transmitting through the substrate to an outside; and
a belt-shaped light-blocking section formed in the substrate at a place other than the light emitting section and colored in a color which can absorb the light emitted from the light introducer and transmitted through the substrate; and
the movable contact is formed under the light emitting section of the light guide sheet.

6. A switch comprising:
a movable contact body including a light guide sheet and a dome-shaped movable contact made of sheet metal;
a light introducer located at a position from which light from the light introducer can be introduced on an end of the light guide sheet; and
a wiring board having two fixed contacts on a position where the movable contact is located, the position being on a side of the wiring board where the movable contact body is formed,
wherein the light guide sheet comprises:
a film-shaped substrate;
a light emitting section formed on the substrate, the light emitting section reflecting or scattering light transmitting through the substrate to an outside; and
a belt-shaped light-blocking section formed in the substrate at a place other than the light emitting section and colored in a color which can absorb the light emitted from the light introducer and transmitted through the substrate, and
the movable contact is formed under the light emitting section of the light guide sheet.

7. A light guide sheet for guiding light emitted from a light introducer, the light guide sheet comprising:
a film-shaped substrate;
a light emitting section formed on the substrate, the light emitting section being composed of at least one of a plurality of projections and a plurality of recesses; and
a belt-shaped light-blocking section formed in the substrate at a place other than the at least one of the projections and the recesses and colored in a color which can absorb the light emitted from the light introducer and transmitted through the substrate.

8. The light guide sheet according to claim 7, wherein the light-blocking section extends through the light emitting section.

9. A movable contact body comprising:
a light guide sheet for guiding light emitted from a light introducer; and
a dome-shaped movable contact made of sheet metal,
wherein the light guide sheet comprises:
a film-shaped substrate;
a light emitting section formed on the substrate, the light emitting section being composed of at least one of a plurality of projections and a plurality of recesses; and
a belt-shaped light-blocking section formed in the substrate at a place other than the at least one of the projections and the recesses and colored in a color which can absorb the light emitted from the light introducer and transmitted through the substrate, and
the movable contact is formed under the light emitting section of the light guide sheet.

10. A switch comprising:
a movable contact body including a light guide sheet and a dome-shaped movable contact made of sheet metal;
a light introducer located at a position from which light from the light introducer can be introduced on an end of the light guide sheet; and
a wiring board having two fixed contacts on a position where the movable contact is located, the position being on a side of the wiring board where the movable contact body is formed,
wherein the light guide sheet comprises:
a film-shaped substrate;
a light emitting section formed on the substrate, the light emitting section being composed of at least one of a plurality of projections and a plurality of recesses;
a belt-shaped light-blocking section formed in the substrate at a place other than the at least one of the projections and the recesses and colored in a color which can absorb the light emitted from the light introducer and transmitted through the substrate, and
the movable contact is formed under the light emitting section of the light guide sheet.

11. The light guiding sheet according to claim 1, wherein the light-blocking section is formed in a groove in one or both sides of the substrate.

12. The light guiding sheet according to claim 1, further comprising:
another light-blocking section formed in the substrate,
wherein the light emitting section includes at least one of a plurality of projections and a plurality of recesses, and the light-blocking section is formed at a place other than positions of the at least one of the plurality of projection and the plurality of recesses.
